(19) United States
(12) Patent Application Publication
(10) Pub. No.: US 2006/0029263 A1
(43) Pub. Date: Feb. 9, 2006

(54) Method, apparatus and storage medium for processing an image

(76) Inventor: Yue Zhang, Beijing (CN)

Correspondence Address: FITZPATRICK CELLA HARPER & SCINTO, 30 ROCKEFELLER PLAZA, NEW YORK, NY, 10112, US

(21) Appl. No.: 11/190,006

(22) Filed: Jul. 27, 2005

(30) Foreign Application Priority Data
Aug. 9, 2004 (CN) 2004/10055168.9

(51) Int. Cl. G06K 9/00

(52) U.S. Cl. 382/117

(57) ABSTRACT

The present invention provides a method of processing an image, characterized by comprising steps of: identifying a face region in said image; identifying a candidate for rod eye region within said face region; selecting a geometric figure which at least partly covers said candidate for red eye region and has the same orientation with said face region; calculating at least one characteristic value for said geometric figure; classifying said candidate for red eye region based on said at least one characteristic value. Red eyes are detected only in a face image and based on shape. Both speed and accuracy are increased in detection.

This application claims priority from Chinese Patent Application No. 200410055168.9 filed on Aug. 9, 2004, which is incorporated hereby by reference.

### FIELD OF THE INVENTION

The present invention relates to image processing, and particularly to the method, apparatus and storage medium for processing an image in which red eyes are detected.

### BACKGROUND OF THE INVENTION

Red eye is the appearance of an unnatural red hue around a person's pupil. It is usually caused by the light of flash reflection from the blood vessels. At present, there are numerous methods of identifying red eyes.

In the existent methods of identifying red eyes, candidates for red eye regions are first identified in a digital image, and then further detections or calculations are made to determine whether the candidates for red eye regions are red eyes or not. Usually, red eyes are detected by color, not by shape. Occasionally, there are some red eye-like-regions in the image, so detection method only based on color will generate many false red eyes. In such cases, the accuracy of color-based detection method is not high.

### SUMMARY OF THE INVENTION

The objective of the present invention is to provide a method, an apparatus and a storage medium for processing an image in which red eyes are detected by shape.

For achieving the above objective, the present invention provides a method of processing an image, characterized by comprising steps of:
identifying a face region in said image;
identifying a candidate for red eye region within said face region;
selecting a geometric figure which at least partly covers said candidate for red eye region and has the same orientation with said face region;
calculating at least one characteristic value for said geometric figure;
classifying said candidate for red eye region based on said at least one characteristic value.

The present invention further provides an apparatus for processing an image, characterized by comprising:
a face region identifier circuit, for identifying a face region in said image;
a candidate identifier circuit, for identifying a candidate for red eye region within said face region;
a geometric figure selector, for selecting a geometric figure which at least partly covers said candidate for red eye region and has the same orientation with said face region;
a calculator for calculating at least one characteristic value for said geometric figure;
a classifier, for classifying said candidate for red eye region based on said at least one characteristic value.

The present invention further provides a storage medium encoded with machine-readable computer program code for processing an image, the storage medium including instructions for causing a processor to implement the method according to the present invention.

According to the method, apparatus and storage medium of the present invention, red eyes are detected based on the shape of a geometric figure which at least partly covers the candidate for red eye region and has the same orientation with the face region. And red eyes are detected only in the face region that has been detected in the image rather than in the whole image. Both speed and accuracy of detecting red eyes are increased.

Additionally, the method of the present invention can be easily combined with various conventional methods of identifying candidates for red eye regions so as to fit in different situations.

Other features and advantages of the present invention will be more clear from the following description of the preferred embodiments, taken in conjunction with the accompanying drawings, which illustrate, by way of example, the principles of the invention.

### BRIEF DESCRIPTION OF THE DRAWINGS

FIG. 1 is a flow chart of the method of processing an image according one embodiment of the present invention;

FIG. 2 schematically illustrates the basic principle of the embodiment;

FIG. 3 is a block diagram of the apparatus for processing an image according to another embodiment of the present invention;

FIGS. 4A, 4B and 4C show an example of a candidate for red eye region;

FIGS. 5P, 5B and 5C show another example of a candidate for red eye region;

FIG. 6 schematically shows an image processing system in which the method shown in FIG. 1 can be implemented;

FIG. 7 shows an exemplified method of identifying an eye area in an image;

FIG. 8 shows an exemplified method of identifying a face rectangle in an image;

FIG. 9 shows an exemplified method of identifying a candidate for red eye region in an image.

### DETAILED DESCRIPTION OF THE PREFERRED EMBODIMENT

In the following description, as to how to identify a candidate for human face region, how to identify eye areas in a human face, reference can be made to Chinese Patent Application No. 001270672 filed by the same applicant on Sep. 15, 2000, Chinese Patent Application No. 01132807.X filed by the same applicant on Sep. 6, 2001, Chinese Patent Application No. 02155468.4 filed by the same applicant on Dec. 13, 2002, Chinese Patent Application No. 02160016.3 filed by the same applicant on Dec. 30, 2002, Chinese Patent Application No 03137345.3 filed by the same applicant on Jun. 18, 2003, etc. These applications are incorporated here for reference. However, the method of identifying candidates for human face region and method of identifying eye areas disclosed in these applications constitute no restriction to the present invention. Any conventional method of identifying candidates for human face region or method of identifying eye areas within an image may be utilized in the present invention.

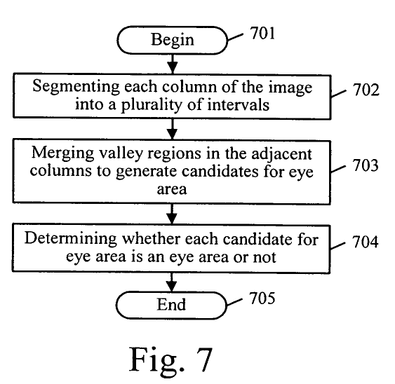

FIG. 7 shows an exemplified method of identifying an eye area in an image. The method begins at step 701. Then at step 702, each column of the image is segmented into a plurality of intervals.

At step 703, valley regions in the adjacent columns are merged in order to generate candidates for eye area. Then, at step 704, it is determined whether each candidate for eye area is a real eye area or a false eye area.

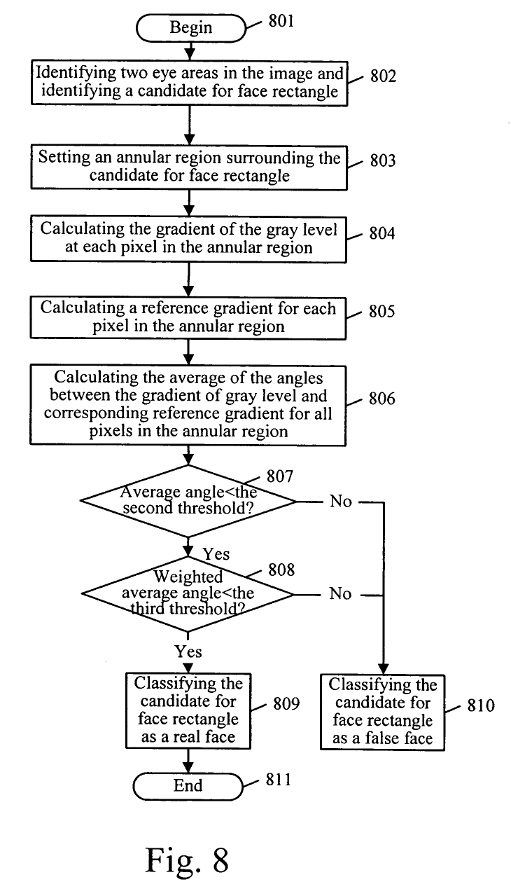

FIG. 8 shows an exemplified method of identifying a face rectangle in an image. The method begins at step 801. Then at step 802, two eye areas are identified in the image, and based on the two eye areas, a candidate for face rectangle is identified.

At step 803, an annular region surrounding the candidate for face rectangle is set. At step 804, for each pixel in the annular region, the gradient of the gray level is calculated. At step 805, for each pixel in the annular region, a reference gradient is calculated. At step 806, an average of the angles between the gradient of gray level and corresponding reference gradient for all pixels in the annular regions is calculated. At step 807, it is decided whether the average angle is less than the second threshold. If the decision of step 807 is “No”, the process goes to step 810; otherwise, to step 808.

At step 808, it is decided whether the weighted average angle is less than the third threshold. If the decision of step 808 is “No”, the process goes to step 810; otherwise, to step 809.

At step 809, the candidate for face rectangle is classified as a face rectangle (i.e., true face). At step 810, the candidate for face rectangle is classified as a false face (i.e., false face).

The process ends at step 811.

For more explanation of the methods shown in FIGS. 7 and 8, reference may be made to Chinese patent application No 01132807.X.

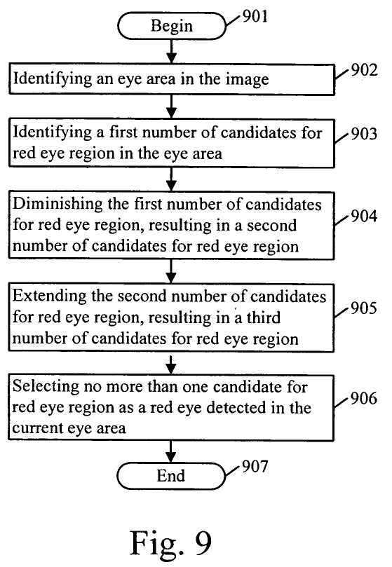

FIG. 9 shows an exemplified method of identifying a candidate for red eye region in an image. The method begins at step 901. Then at step 902, an eye area is identified in the image.

At step 903, a first number of candidates for red eye region are identified in the eye area. In order to identify a candidate for red eye region in the eye area, characteristic values of pixels in the eye area are considered. At step 903, the color variance, or the texture, or the combination of color variance and texture of pixels in the eye area are for example considered.

At step 904, the first number of candidates for red eye region are diminished. As a result, a second number of candidates for red eye region are resulted.

According to the process of diminishing, at least one characteristic value of each pixel in each of the first number of candidates for red eye region is evaluated. If the evaluated characteristic value does not meet a standard set for red eye pixel, the evaluated pixel is removed from the relevant candidate for red eye region. Thus, the areas of most of the first number of candidates for red eye region are reduced. If all pixels included in a candidate for red eye region are removed, this candidate for red eye region does not exist and is not considered any more.

Thus, the second number, i.e., the total number of candidates for red eye region after step 904 is performed, may be less than the first number, i.e., the total number of candidates for red eye region before step 904 is performed.

At step 905, the second number of candidates for red eye region are extended. As a result, a third number of candidates for red eye region are resulted.

In this stop, border pixels of each of the second number of candidates for red eye region are considered. A “border pixel” refers to a pixel located at the edge of a candidate for red eye region. If pixels in the vicinity of a border pixel meets a standard set for red eye pixel, these pixels are included into relevant candidate for red eye region. Thus, the areas of most of the second number of candidates for red eye region are increased, and inevitably some candidates for red eye region may merge with one another. This introduces another function of step 905.

Another function of step 905 is to selectively remove candidates for red eye region that merge, to selectively combine candidates for red eye region that merge, or to selectively keep one of the candidates for red eye region that merge while removing others.

The candidates for red eye region that are removed are not considered any more.

Thus, the third number, i.e., the total number of candidates for red eye region after step 905 is performed, may be less than the second number, i.e., the total number of candidates for red eye region before step 905 is performed.

At step 906, no more than one candidate for red eye region is selected as a red eye that is detected in the eye area.

In step 506, a lot of characteristic values of the pixels in the third number of candidates for red eye region are evaluated. Based on the evaluation results, most of the third number of candidates for red eye region are removed. The left candidates for red eye region are then scored and only the candidate for red eye region with the greatest score is further considered. If the only candidate for red eye region with the greatest score meets a standard, it is selected as a red eye detected in the current eye area. Otherwise, no red eye is detected in the current eye area.

At step 907, the process ends.

For more explanation of the method shown in FIG. 9, reference may be made to Chinese patent application No. 200310116034.9.

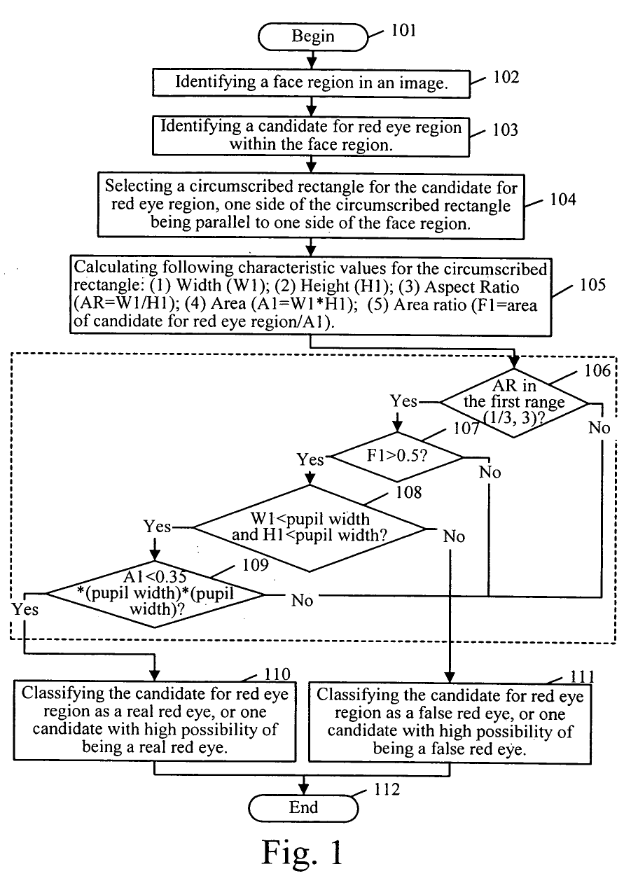

FIG. 1 is a flow chart of the method of processing an image according one embodiment of the present invention.

As shown in FIG. 1, the process begins at step 101. Then at step 102, a face region is identified in the image to be processed. Next, at step 103, a candidate for red eye region is identified within the face region. Different ways of identifying face region in an image and different ways of identifying a candidate for red eye region within a face region constitute no restriction to the present invention.

Then, at step 104, a circumscribed rectangle is selected for the candidate for red eye region. Since the shape of the candidate for red eye region is indefinite, in theory, there are unlimited circumscribed rectangles for the candidate for red eye region. Among these unlimited circumscribed rectangles, only one is selected at step 104. One of the four sides of the selected circumscribed rectangle is parallel to one of the four sides of the face region.

At step 105, at least one characteristic value is calculated for the selected circumscribed rectangle. For example, the at least one characteristic value include any one or more of the following values:
(1) The width (W1) of the circumscribed rectangle;
(2) The height (H1) of the circumscribed rectangle;
(3) The aspect ratio of the circumscribed rectangle, which is defined as AR=W1/H1;
(4) The area of the circumscribed rectangle, which is defined as A1=W1*H1;
(5) The area ratio of the circumscribed rectangle, which is defined as F1=(area of the candidate for red eye region)/A1.

The above characteristic values are only examples. In addition to the above characteristic values, other values may also be considered in the present invention. Different kinds of characteristic values of the selected circumscribed rectangle, different orientations of the selected circumscribed rectangle, and different shapes of the face region constitute no restriction to the present invention.

Then, at step 106, it is decided whether the aspect ratio (i.e., AR) of the circumscribed rectangle is within the first range. For example, the first range is (⅓, 3). If the result of step 106 is “No”, the process goes to step 111; otherwise step 107.

At step 107, it is decided whether the area ratio (i.e., F1) of the circumscribed rectangle is greater than the first predetermined number. For example, the first predetermined number is 0.5. If the result of step 107 is “No”, the process goes to step 111; otherwise step 108.

At step 108, it is decided whether both the width (i.e., W1) and the height (i.e., H1) of the circumscribed rectangle are less than the width of the pupil. For example, the width of the pupil may be defined as ⅕ times the width of the face region. Here, the width of the face region may be defined as the minimum of the width of face region and the height of the face region. If the result of step 108 is “No”, the process goes to step 111; otherwise step 109.

At step 109, it is decided whether the area (i.e., A1) of the circumscribed rectangle is less than the second predetermined number times the area of the pupil. For example, the second predetermined number is 0.35, and the area of the pupil may be defined as the square of the width of the pupil. If the result of step 109 is “No”, the process goes to step 111; otherwise step 110.

The combination the decision blocks 106, 107, 108 and 109, as included in the broken block in FIG. 1, is just an example. Any combination of blocks 106, 107, 108 and 109, and even a single block among blocks 106, 107, 108 and 109, are workable in FIG. 1. Thus, the combination of blocks 106, 107, 106 and 109 as shown in FIG. 1 does not constitute any restriction to the present invention. Besides, decisions blocks concerning other values may also be included in the broken block in FIG. 1.

At step 111, the candidate for red eye region is classified as a false red eye, or a candidate with high possibility of being a false red eye.

At step 110, the candidate for red eye region is classified as a true red eye, or a candidate with high possibility of being a true red eye.

Both steps 111 and 110 are followed by step 112.

At step 112, the process ends.

In addition to the circumscribed rectangle for the candidate for red eye region, other geometric figures that at least partly cover the candidate for red eye region and have the same orientation with the face region may be selected at step 105, and corresponding characteristic values may be calculated for these other geometric figures at step 105.

For example, one of such other geometric figures may be an inscribed ellipse for the circumscribed rectangle for the candidate for red eye region. In order to identify such an inscribed ellipse, the following steps may be taken. First, in the coordinate system of the face region, get the maximum X coordinate (max_x), the minimum X coordinate (min_x), the maximum Y coordinate (max_y), and the minimum Y coordinate (min_y) for all pixels included in the candidate for red eye region.

Second, let the center of the ellipse be [(max_x+min_x)/2, (max_y+min_y)/2]; lot the major axis of the ellipse be (max_x−min_x+1)/2; and let the minor axis of the ellipse be (max_y−min_y+1)/2.

Then the ellipse may be constructed.

The characteristic values for the ellipse may include a ratio of major axis to minor axis of the ellipse. The candidate for red eye region is classified as a false red eye, or a candidate with high possibility of being a false red eye, if the ratio of major axis to minor axis is outside a first range of ⅓ to 3.

The characteristic values for the ellipse may also include an area ratio of the ellipse. The candidate for red eye region is classified as a false red eye, or a candidate with high possibility of being a false red eye, if the area ratio is less than a first predetermined number. The area ratio is a ratio of the number of pixels included in both the candidate for red eye region and the ellipse to an area of the ellipse. The first predetermined number is 0.5.

The characteristic values for the ellipse may also include the major axis of the ellipse and the minor axis of the ellipse. The candidate for red eye region is classified as a false red eye, or a candidate with high possibility of being a false red eye, if the major axis of the ellipse is greater than the width of the pupil. And the candidate for red eye region is classified as a false red eye, or a candidate with high possibility of being a false red eye, if the minor axis of the ellipse is greater than the width of the pupil. The width of the pupil is one fifth of the minimum of the width of the face region and the height of the face region.

The characteristic values for the ellipse may also include the area of the ellipse. The candidate for red eye region is classified as a false red eye, or a candidate with high possibility of being a false red eye, if the area of the ellipse is less than a second predetermined number times the area of the pupil. The second predetermined number is 0.3. The area of the pupil is the square of the width of the pupil. The width of the pupil is one fifth of the minimum of the width of the face region and the height of the face region.

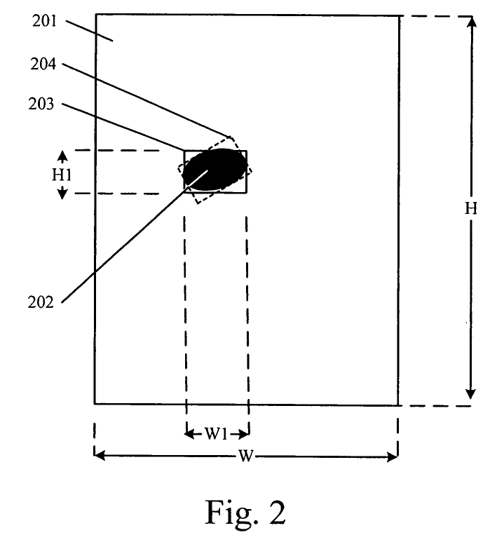

FIG. 2 schematically illustrates the basic principle of the embodiment.

As shown in FIG. 2, reference numeral 201 denotes a face region, 202 a candidate for red eye region, 203 a circumscribed rectangle for the candidate for red eye region 202, 204 another circumscribed rectangle for the candidate for red eye region 202.

The basic principle of the embodiment is described as follows with reference to FIGS. 1 and 2.

Initially, face region 201 is identified in the image to be processed.

Then, for example, candidate for red eye region 202 is identified within face region 201. There may be a plurality of candidates for red eye region 202 that may be identified within face region 201. FIG. 2 just shows an example.

Candidate for red eye region 202 has a plurality of circumscribed rectangles, including circumscribed rectangles 203 and 204. Among all these circumscribed rectangles, only one particular circumscribed rectangle is in the same orientation as face region 201. That is to say, if face region 201 is a rectangle, then there is only one particular circumscribed rectangle whose one side is parallel to one side of face region 201. In FIG. 2, this particular circumscribed rectangle is denoted as 203. This particular circumscribed rectangle is selected in the present invention for further processing.

As shown in the FIG. 2, the width of face region 201 is denoted as W. The height of face region 201 is denoted as H. For simplicity, of course, the width of face region 201 may be defined as the minimum of W and H.

The width of circumscribed rectangle 203 is denoted as W1. The height of circumscribed rectangle 203 is denoted as H1. The aspect ratio of circumscribed rectangle 203 is defined as W1/H1. The area of circumscribed rectangle 203 is defined as W1*H1. The area ratio of circumscribed rectangle 203 is defined as the percentage of the area of candidate for red eye region 202 in circumscribed rectangle 203, i.e., (area of candidate for red eye region 202)/(W1*H1).

The above characteristic values, as well as other characteristic values if any, of circumscribed rectangle 203 are calculated according to the present invention.

Based on one or more of the calculated characteristic values of circumscribed rectangle 203, candidate for red eye region 202 is classified as a false red eye, a candidate with high possibility of being a false red eye, a true red eye, or a candidate with high possibility of being a true red eye.

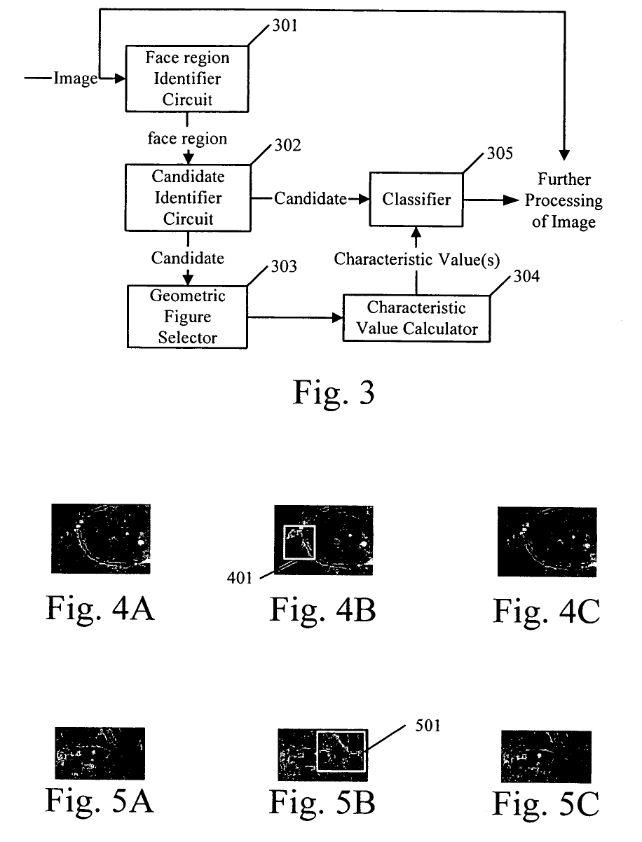

FIG. 3 is a block diagram of the apparatus for processing an image according to another embodiment of the present invention.

In FIG. 3, reference numeral 301 denotes a face region identifier circuit, 302 a candidate identifier circuit, 303 a geometric figure selector, 304 a characteristic value calculator, 305 a classifier.

Face region identifier circuit 301, receives the image to be process, and identifies a face region in the received image. Candidate identifier circuit 302 identifies a candidate for red eye region within the face region outputted by face region identifier circuit 301. Geometric figure selector 303 selects a geometric figure which at least partly covers the candidate for red eye region and has the same orientation with the face region.

Characteristic value calculator 304 calculates at least one characteristic value for the geometric figure selected by geometric figure selector 303. Here, the at least one characteristic value has the same meaning as that described with reference to FIGS. 1 and 2.

If the geometric figure is a circumscribed rectangle for the candidate for red eye region, characteristic value calculator 304 calculates any one or more of the following values:
(1) The width (W1) of the circumscribed rectangle;
(2) The height (H1) of the circumscribed rectangle;
(3) The aspect ratio of the circumscribed rectangle, which is defined as AR=W1/B1;
(4) The area of the circumscribed rectangle, which is defined as A1=W1*H1;
(5) The area ratio of the circumscribed rectangle, which is defined as F1=(area of the candidate for red eye region)/A1.

If the geometric figure is an inscribed ellipse for the circumscribed rectangle for the candidate for red eye region, characteristic value calculator 304 calculates any one or more of the following values:
(1) The major axis (Xaxis) of the inscribed ellipse;
(2) The minor axis (Yaxis) of the inscribed ellipse;
(3) The ratio of major axis to minor axis of the inscribed ellipse, which is defined as Xaxis/Yaxis;
(4) The area (EllipseArea) of the inscribed ellipse;
(5) The area ratio (EllipseAreaRatio) of the inscribed ellipse; which is defined as:
   (the number of pixels included in both the candidate for red eye region and the ellipse)/ElllpseArea.

The above characteristic values are only examples. In addition to the above characteristic values, other values may also be calculated by characteristic value calculator 304. Different kinds of characteristic values to be calculated for the selected circumscribed rectangle constitute no restriction to the present invention.

Classifier 305, based on the at least one characteristic value outputted by characteristic value calculator 304, classifies the candidate for red eye region outputted by candidate identifier circuit 302 as a false red eye, a candidate with high possibility of being a false red eye, a true red eye, or a candidate with high possibility of being a true red eye.

The conditions for classifying the candidate for red eye region are the same as those described with respect to FIG. 1.

Although it is shown in FIG. 3 that the candidate for red eye region that has been identified by candidate identifier circuit 302 is inputted to classifier 305, it is not necessary to do so in practice. What is important here is that classifier 305 knows which candidate for red eye region is to be classified when it receives the outputs (i.e., characteristic values of a selected geometric figure for the candidate for red eye region) from characteristic value calculator 304.

The classification result of classifier 305 can be used for further processing of the image.

It should be noted that any characteristic values may be calculated by characteristic value calculator 304 for the geometric figure that is selected for the candidate for red eye region, as long as the characteristic values outputted by characteristic value calculator 304 are sufficient for classifier 305 to classify the candidate for red eye region as a false zed eye, a candidate with high possibility of being a false red eye, a true red eye, or a candidate with high possibility of being a true red eye.

FIGS. 4A, 4B and 4C show an example of a candidate for red eye region.

FIG. 4A shows the original picture. FIG. 4B shows a candidate for redeye region 401 is identified in the picture shown in FIG. 4A. In FIG. 4B, the following values are calculated:
W1=35 (or Xaxis=35);
H1=32 (or Yaxis=32);
A1=W1*H1=1120;
W=307;
H=379;
The width of pupil=⅕*minimum(W,H)=61.4;
Area of candidate for red eye region=167;
AR=W1/H1=1.09 (or Xaxis/Yaxis=1.09);
F1=(area of candidate for red eye region)/A1=0.15;
0.35*square(width of pupil)=1319;
EllipseArea=879;
EllipseAreaRatio= 128/879=0.15;
0.3*square(width of pupil)=1130.

Apparently from above, F1 is less than 0.5. Thus candidate for rod eye region 401 is classified as a false red eye according to the embodiment. Alternatively, since EllipseAreaRatio is less than 0.5, candidate for red eye region 401 is classified as a false red eye according to the embodiment.

That is, based on the prior art, candidate for red eye region 401 in FIG. 4B is classified as a red eye. According to the present invention, however, candidate for red eye region 401 is not classified as a red eye, as shown in FIG. 4C.

FIGS. 5A, 5B and 5C show another example of a candidate for red eye region.

FIG. 5A shows the original picture. FIG. 5B shows a candidate for red eye region 501 is identified in the picture shown in FIG. 5A. In FIG. 5B, the following values are calculated:
W1=47 (or Xaxis=47);
H1=42 (or Yaxis=42);
A1=W1*H1=1974;
W=331;
The width of pupil=⅕*minimum(W,H)=66.2;
Area of candidate for red eye region=1111;
AR=W1/H1=1.12 (or Xaxis/Yaxis=1.12);
F1=(area of candidate for red eye region)/A1=0.56;
0.35+square(width of pupil)=1533;
EllipseArea=1550;
EllipseAreaRatio= 1028/1550=0.66;
0.3*square(width of pupil)=1341.

Apparently from above, A1 is greater than 0.35*square (width of pupil). Thus candidate for red eye region 501 is classified as a false red eye according to the embodiment. Alternatively, since EllipseArea is greater than 0.3*square(width of pupil), candidate for red eye region 501 is classified as a false red eye according to the embodiment.

That is, based on the prior art, candidate for red eye region 501 in FIG. 5B is classified as a zed eye. According to the present invention, however, candidate for red eye region 501 is not classified as a red eye, as shown in FIG. 5C.

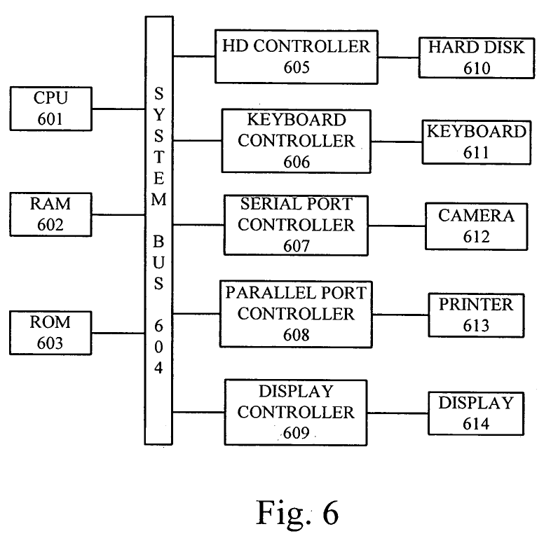

FIG. 6 schematically shows an image processing system in which the method shown in FIG. 1 can be implemented. The image processing system shown in FIG. 6 comprises a CPU (Central Processing Unit) 601, a RAM (Random Access Memory) 602, a ROM (Read only Memory) 603, a system bus 604, a HD (Hard Disk) controller 605, a keyboard controller 606, a serial port controller 607, a parallel port controller 608, a display controller 609, a hard disk 610, a keyboard 611, a camera 612, a printer 613 and a display 614. Among these components, connected to system bus 604 are CPU 601, RAM 602, ROM 603, BD controller 605, keyboard controller 606, serial port controller 607, parallel port controller 608 and display controller 609. Hard disk 610 is connected to HD controller 605, and keyboard 611 to keyboard controller 606, camera 612 to serial port controller 607, printer 613 to parallel port controller 608, and display 614 to display controller 609.

The functions of each component in FIG. 6 are well known in the art and the architecture shown in FIG. 6 is conventional. Such an architecture not only applies to personal computers, but also applies to hand held devices such as Palm PCs, PDAs (personal data assistants), digital cameras, etc. In different applications, some of the components shown in FIG. 6 may be omitted. For instance, if the whole system is a digital camera, parallel port controller 608 and printer 613 could be omitted, and the system can be implemented as a single chip microcomputer. If application software is stored in a computer readable storage medium such as EPROM or other non-volatile memories, HD controller 605 and hard disk 610 could be omitted.

The whole system shown in FIG. 6 is controlled by computer readable instructions, which are usually stored as software in a computer readable storage medium—hard disk 610 (or as stated above, in EPROM, or other non-volatile memory). The software can also be downloaded from the network (not shown in the figure). The software, either saved in hard disk 610 or downloaded from the network, can be loaded into RAM 602, and executed by CPU 601 for implementing the functions defined by the software.

It involves no inventive work for persons skilled in the art to develop one or more pieces of software based on the flowchart shown in FIG. 1. The software thus developed will carry out the method of processing an image shown in FIG. 1.

In some sense, the image processing system shown in FIG. 6, if supported by software developed based on flowchart shown in FIG. 1, achieves the same functions as the apparatus for processing image shown in FIG. 3.

The present invention also provides a storage medium encoded with machine-readable computer program code for processing an image, the storage medium including instructions for causing a processor to implement the method according to the present invention. The storage medium may be any tangible media, such as floppy diskettes, CD-ROMs, hard drives (e.g., hard disk 610 in FIG. 6).

While the foregoing has been with reference to specific embodiments of the invention, it will be appreciated by those skilled in the art that these are illustrations only and that changes in these embodiments can be made without departing from the principles of the invention, the scope of which is defined by the appended claims.

What is claimed is:

1. A method of processing an image, characterized by comprising steps of:
identifying a face region in said image;
identifying a candidate for red eye region within said face region;
selecting a geometric figure which at least partly covers said candidate for red eye region and has the same orientation with said face region;
calculating at least one characteristic value for said geometric figure;
classifying said candidate for red eye region based on said at least one characteristic value.

2. The method of processing an image according to claim 1, characterized in that said geometric figure is a circumscribed rectangle for said candidate for red eye region.

3. The method of processing an image according to claim 2, characterized in that said at least one characteristic value includes an aspect ratio of said circumscribed rectangle, and that said candidate for red eye region is classified as a false red eye, or a candidate with high possibility of being a false red eye, if said aspect ratio is outside a first range.

4. The method of processing an image according to claim 2, characterized in that said at least one characteristic value includes an area ratio of said circumscribed rectangle, and that said candidate for red eye region is classified as a false red eye, or a candidate with high possibility of being a false red eye, if said area ratio is less than a first predetermined number.

5. The method of processing an image according to claim 2, characterized in that said at least one characteristic value includes a width of said circumscribed rectangle and a height of said circumscribed rectangle, that said candidate for red eye region is classified as a false red eye, or a candidate with high possibility of being a false red eye, if said width of said circumscribed rectangle is greater than a width of a pupil, and that said candidate for red eye region is classified as a false red eye, or a candidate with high possibility of being a false red eye, if said height of said circumscribed rectangle is greater than said width of said pupil.

6. The method of processing an image according to claims 5, characterized in that said width of said pupil is one fifth of a minimum of a width of said face region and a height of said face region.

7. The method of processing an image according to claim 2, characterized in that said at least one characteristic value includes an area of said circumscribed rectangle, and that said candidate for red eye region is classified as a false red eye, or a candidate with high possibility of being a false red eye, if said area of said circumscribed rectangle is less than a second predetermined number times an area of a pupil.

8. The method of processing an image according to claim 1, characterized in that said geometric figure is an inscribed ellipse for a circumscribed rectangle for said candidate for red eye region.

9. The method of processing an image according to claim 8, characterized in that said at least one characteristic value includes a ratio of major axis to minor axis of said inscribed ellipse, and that said candidate for red eye region is classified as a false red eye, or a candidate with high possibility of being a false red eye, if said ratio of major axis to minor axis is outside a first range.

10. The method of processing an image according to claim 8, characterized in that said at least one characteristic value includes an area ratio of said inscribed ellipse, and that said candidate for red eye region is classified as a false red eye, or a candidate with high possibility of being a false red eye, if said area ratio is less than a first predetermined number.

11. The method of processing an image according to claim 8, characterized in that said at least one characteristic value includes a major axis of said inscribed ellipse and a minor axis of said inscribed ellipse, that said candidate for red eye region is classified as a false red eye, or a candidate with high possibility of being a false red eye, if said major axis of said inscribed ellipse is greater than a width of a pupil, and that said candidate for red eye region is classified as a false red eye, or a candidate with high possibility of being a false red eye, if said minor axis of said inscribed ellipse is greater than said width of said pupil.

12. The method of processing an image according to claim 11, characterized in that said width of said pupil is one fifth of a minimum of a width of said face region and a height of said face region.

13. The method of processing an image according to claim 8, characterized in that said at least one characteristic value includes an area of said inscribed ellipse, and that said candidate for red eye region is classified as a false red eye, or a candidate with high possibility of being a false red eye, if said area of said inscribed ellipse is less than a second predetermined number times an area of a pupil.

14. An apparatus for processing an image, characterized by comprising:
a face region identifier circuit, for identifying a face region in said image;
a candidate identifier circuit, for identifying a candidate for red eye region within said face region;
a geometric figure selector, for selecting a geometric figure which at least partly covers said candidate for red eye region and has the same orientation with said face region;
a calculator for calculating at least one characteristic value for said geometric figure;
a classifier, for classifying said candidate for red eye region based on said at least one characteristic value.

15. The apparatus for processing an image according to claim 14, characterized in that said geometric figure is a circumscribed rectangle for said candidate for red eye region.

16. The apparatus for processing an image according to claim 15, characterized in that said calculator calculates an aspect ratio of said circumscribed rectangle, and that said classifier classifies said candidate for red eye region as a false red eye, or a candidate with high possibility of being a false red eye, if said aspect ratio is outside a first range.

17. The apparatus for processing an image according to claim 14, characterized in that said geometric figure is an inscribed ellipse for a circumscribed rectangle for said candidate for red eye region.

18. A storage medium encoded with machine-readable computer program code for processing an image, the storage medium including instructions for causing a processor to implement the method according to any one of claims 1 to 13.
